(19) United States
(12) Patent Application Publication
(10) Pub. No.: US 2016/0299570 A1
(43) Pub. Date: Oct. 13, 2016

(54) WRISTBAND DEVICE INPUT USING WRIST MOVEMENT

(71) Applicant: Apple Inc., Cupertino, CA (US)

(72) Inventor: Anton M. Davydov, Gilroy, CA (US)

(73) Assignee: Apple Inc., Cupertino, CA (US)

(21) Appl. No.: 15/031,705

(22) PCT Filed: Oct. 24, 2013
(86) PCT No.: PCT/US2013/066689

§ 371 Date: Apr. 22, 2016

(51) Int. Cl. G06F 3/01; G06F 3/16; G06F 3/0482; G06F 1/16; G06F 3/0485

(52) U.S. Cl. CPC G06F 3/017; G06F 1/163; G06F 3/0485; G06F 3/0482; G06F 3/167

(57) ABSTRACT

A function of an electronic device can be invoked using a wrist gesture (e.g., flexion or extension) that is detected by a wrist-worn device. The gesture can be detected using sensors in the wrist-worn device, e.g., in the wristband and/or behind a face member. A specific gesture can be identified from a library based on analysis of sensor signals. The invoked function can be executed on the wrist-worn device or another device that is in communication with the wrist-worn device.

### BACKGROUND

The present disclosure relates generally to wearable electronic devices and in particular to providing user input using wrist movement and a wrist-worn device.

Mobile electronic devices, such as mobile phones, smart phones, tablet computers, media players, and the like, have become quite popular. Many users carry a device almost everywhere they go and use their devices for a variety of purposes, including making and receiving phone calls, sending and receiving text messages and emails, navigation (e.g., using maps and/or a GPS receiver), purchasing items in stores (e.g., using contactless payment systems), and/or accessing the Internet (e.g., to look up information).

However, a user's mobile device is not always readily acccessible. For instance, when a mobile device receives a phone call, the device may be in a user's bag or pocket, and the user may be walking, driving, carrying something, or involved in other activity that makes it inconvenient or impossible for the user to reach into the bag or pocket to find the device.

### SUMMARY

Certain embodiments of the present invention relate to invoking a function of an electronic device using a wrist gesture (e.g., flexion or extension) that is detected by a wrist-worn device. The invoked function can be executed on the wrist-worn device or another device that is in communication with the wrist-worn device. The wrist-worn device can include a wristband that incorporates one or more sensors capable of detecting changes in the position of the wearer's wrist, e.g., by detecting deformation of the wristband, a force applied to the wristband, a change in pressure against a portion of the wristband, and/or a force or change in pressure applied against the back of the device (i.e., the surface of the device oriented toward the user's wrist). Signals from the wristband sensors can be analyzed to identify a specific wrist gesture. The identified gesture can be interpreted to determine a function to be invoked, for instance by reference to a gesture library that maps specific wrist gestures to functions, or actions, of the wrist-worn device. In some embodiments, the interpretation of a wrist gesture can be context-dependent, e.g., depending on what if any operations are in progress on the wrist-worn device when the gesture is made; thus, the same wrist gesture can initiate different functions in different contexts. In some embodiments, the function or action invoked by a wrist gesture can including sending control signals to another device that is in communication with the wrist-worn device, thereby allowing wrist gestures to be used for remote control.

The following detailed description together with the accompanying drawings will provide a better understanding of the nature and advantages of the present invention.

### BRIEF DESCRIPTION OF THE DRAWINGS

FIG. 1 shows a wearable device communicating wirelessly with a host device according to an embodiment of the present invention.

FIG. 2 is a simplified block diagram of a wearable device according to an embodiment of the present invention.

FIGS. 3A-3F illustrate wrist articulations. Extension (or dorsiflexion) is shown in FIG. 3A; flexion (or palmar flexion) is shown in FIG. 3B; abduction (or radial deviation) is shown in FIG. 3C; adduction (or ulnar deviation) is shown in FIG. 3D; pronation (or inward rotation) is shown in FIG. 3E; and supination (or outward rotation) is shown in FIG. 3F.

FIG. 4 is a simplified block diagram of a wrist-gesture processing system that can be included in a wearable according to an embodiment of the present invention.

FIGS. 5A and 5B illustrate one technique for detecting wrist extension (or dorsiflexion) using sensors according to an embodiment of the present invention.

FIGS. 6A and 6B illustrate another technique for detecting wrist extension (or dorsiflexion) using sensors according to an embodiment of the present invention.

FIGS. 7A and 7B illustrate a technique for detecting wrist articulations using pressure sensors according to an embodiment of the present invention.

FIG. 8 shows a table defining a portion of a wrist-gesture library for a wearable device according to an embodiment of the present invention.

FIG. 9 is a flow diagram of a process for controlling a wrist-worn device using wrist gestures according to an embodiment of the present invention.

### DETAILED DESCRIPTION

Certain embodiments of the present invention relate to invoking a function of an electronic device using a wrist gesture (e.g., flexion or extension) that is detected by a wrist-worn device. The invoked function can be executed on the wrist-worn device or another device that is in communication with the wrist-worn device. The wrist-worn device can include a wristband that incorporates one or more sensors capable of detecting changes in the position of the wearer's wrist, e.g., by detecting deformation of the wristband, a force applied to the wristband, and/or a change in pressure against a portion of the wristband. Signals from the wristband sensors can be analyzed to identify a specific wrist gesture. The identified gesture can be interpreted to determine a function to be invoked, for instance by reference to a gesture library that maps specific wrist gestures to functions, or actions, of the wrist-worn device. In some embodiments, the interpretation of a wrist gesture can be context-dependent, e.g., depending on what if any operations are in progress on the wrist-worn device when the gesture is made; thus, the same wrist gesture can initiate different functions in different contexts. In some embodiments, the function or action invoked by a wrist gesture can including sending control signals to another device that is in communication with the wrist-worn device, thereby allowing wrist gestures to be used for remote control.

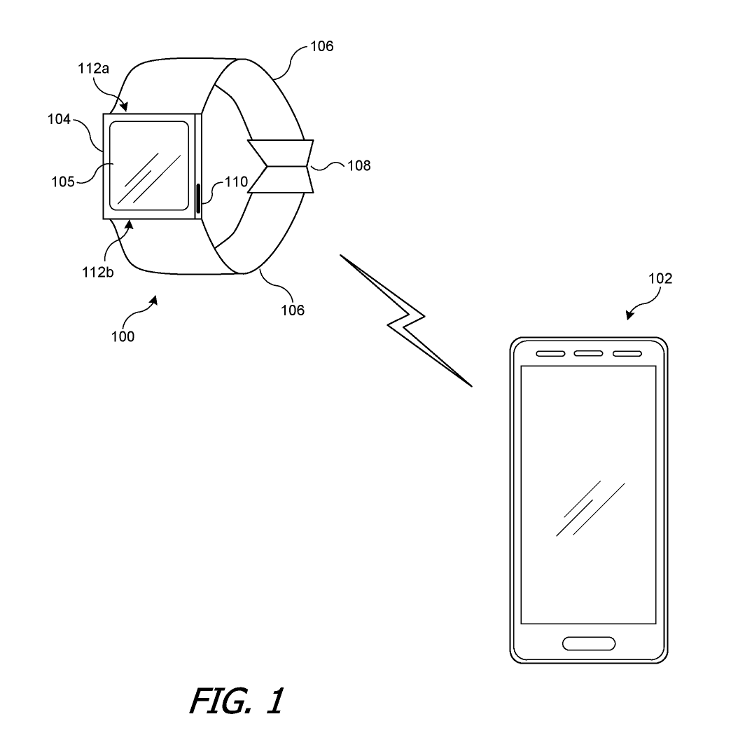

FIG. 1 shows a wearable device 100 communicating wirelessly with a host device 102 according to an embodiment of the present invention. In this example, wearable device 100 is shown as a wristwatch-like device with a face portion 104 connected to a strap 106.

Face portion 104 can include, e.g., a touchscreen display 105 that can be appropriately sized depending on where on a user's person wearable device 100 is intended to be worn. A user can view information presented by wearable device 100 on touchscreen display 105 and provide input to wearable device 100 by touching touchscreen display 105. In some embodiments, touchscreen display 105 can occupy most or all of the front surface of face portion 104.

Strap 106 (also referred to herein as a wristband or wrist strap) can be provided to allow device 100 to be removably worn by a user, e.g., around the user's wrist. In some embodiments, strap 106 can be made of any flexible material (e.g., fabrics, flexible plastics, leather, chains or flexibly interleaved plates or links made of metal or other rigid materials) and can be connected to face portion 104, e.g., by hinges, loops, or other suitable attachment devices or holders. Alternatively, strap 106 can be made of two or more sections of a rigid material joined by a clasp 108. One or more hinges can be positioned at the junction of face 104 and proximal ends 112a, 112b of strap 106 and/or elsewhere along the lengths of strap 106 to allow a user to put on and take off wearable device 100. Different portions of strap 106 can be made of different materials; for instance, flexible or expandable sections can alternate with rigid sections. In some embodiments, strap 106 can include removable sections, allowing wearable device 100 to be resized to accommodate a particular user's wrist size. In some embodiments, strap 106 can be portions of a continuous strap member that runs behind or through face portion 104. Face portion 104 can be detachable from strap 106, permanently attached to strap 106, or integrally formed with strap 106.

In some embodiments, strap 106 can include a clasp 108 that facilitates connection and disconnection of distal ends of strap 106. In various embodiments, clasp 108 can include buckles, magnetic clasps, mechanical clasps, snap closures, etc. In some embodiments, a clasp member can be movable along at least a portion of the length of strap 106, allowing wearable device 100 to be resized to accommodate a particular user's wrist size. Accordingly, device 100 can be secured to a user's person, e.g., around the user's wrist, by engaging clasp 108; clasp 108 can be subsequently disengaged to facilitate removal of device 100 from the user's person.

In other embodiments, strap 106 can be formed as a continuous band of an elastic material (including, e.g., elastic fabrics, expandable metal links, or a combination of elastic and inelastic sections), allowing wearable device 100 to be put on and taken off by stretching a band formed by strap 106 connecting to face portion 104. Thus, clasp 108 is not required.

Strap 106 (including any clasp that may be present) can include sensors that allow wearable device 100 to determine whether it is being worn at any given time. Wearable device 100 can operate differently depending on whether it is currently being worn or not. For example, wearable device 100 can inactivate various user interface and/or RF interface components when it is not being worn. In addition, in some embodiments, wearable device 100 can notify host device 102 when a user puts on or takes off wearable device 100. Further, strap 106 can include sensors capable of detecting wrist articulations of a user wearing device 100; examples of such sensors are described below.

Host device 102 can be any device that communicates with wearable device 100. In FIG. 1, host device 102 is shown as a smart phone; however, other host devices can be substituted, such as a tablet computer, a media player, any type of mobile phone, a laptop or desktop computer, or the like. Other examples of host devices can include point-of-sale terminals, security systems, environmental control systems, and so on. Host device 102 can communicate wirelessly with wearable device 100, e.g., using protocols such as Bluetooth or Wi-Fi. In some embodiments, wearable device 100 can include an electrical connector 110 that can be used to provide a wired connection to host device 102 and/or to other devices, e.g., by using suitable cables. For example, connector 110 can be used to connect to a power supply to charge an onboard battery of wearable device 100.

In some embodiments, wearable device 100 and host device 102 can interoperate to enhance functionality available on host device 102. For example, wearable device 100 and host device 102 can establish a pairing using a wireless communication technology such as Bluetooth. While the devices are paired, host device 102 can send notifications of selected events (e.g., receiving a phone call, text message, or email message) to wearable device 100, and wearable device 100 can present corresponding alerts to the user. Wearable device 100 can also provide an input interface via which a user can respond to an alert (e.g., to answer a phone call or reply to a text message). In some embodiments, wearable device 100 can also provide a user interface that allows a user to initiate an action on host device 102, such as unlocking host device 102 or turning on its display screen, placing a phone call, sending a text message, or controlling media playback operations of host device 102. Techniques described herein can be adapted to allow a wide range of host device functions to be enhanced by providing an interface via wearable device 100.

It will be appreciated that wearable device 100 and host device 102 are illustrative and that variations and modifications are possible. For example, wearable device 100 can be implemented in a variety of wearable articles, including a watch, a bracelet, or the like. In some embodiments, wearable device 100 can be operative regardless of whether host device 102 is in communication with wearable device 100; a separate host device is not required.

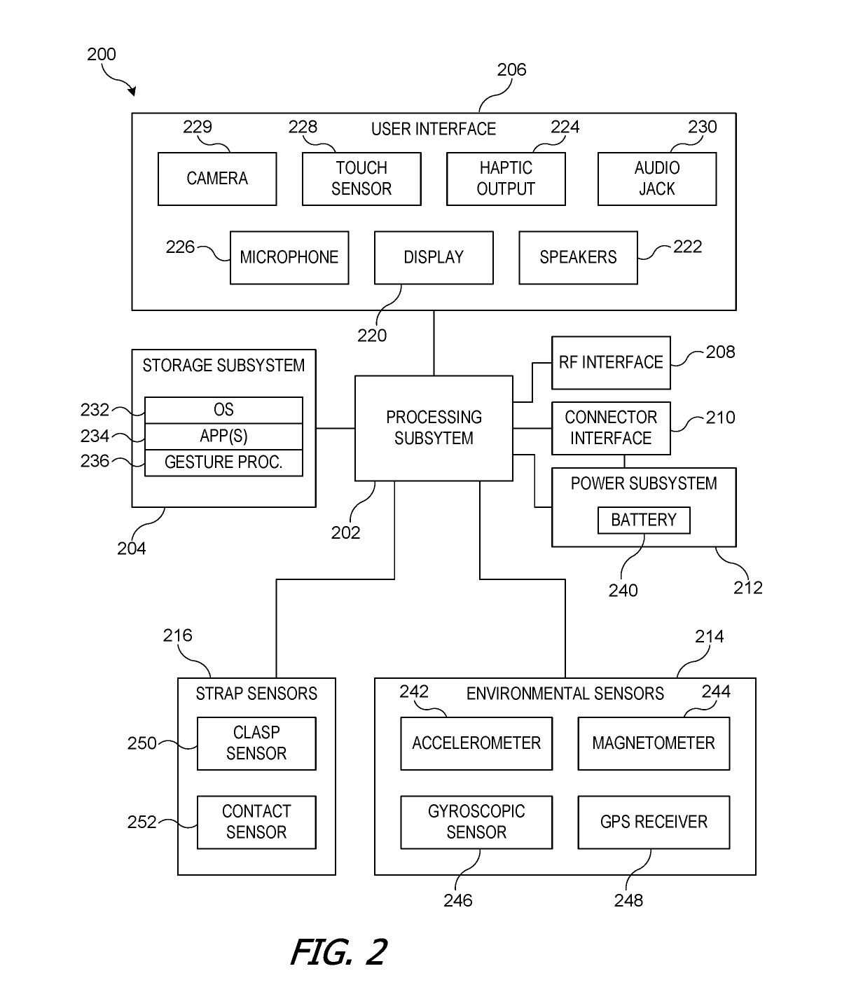

Wearable device 100 can be implemented using electronic components disposed within face portion 104 and/or strap 106. FIG. 2 is a simplified block diagram of a wearable device 200 (e.g., implementing wearable device 100) according to an embodiment of the present invention. Wearable device 200 can include processing subsystem 202, storage subsystem 204, user interface 206, RF interface 208, connector interface 210, power subsystem 212, environmental sensors 214, and strap sensors 216. Wearable device 200 can also include other components (not explicitly shown).

Storage subsystem 204 can be implemented, e.g., using magnetic storage media, flash memory, other semiconductor memory (e.g., DRAM, SRAM), or any other non-transitory storage medium, or a combination of media, and can include volatile and/or non-volatile media. In some embodiments, storage subsystem 204 can store media items such as audio files, video files, image or artwork files; information about a user's contacts (names, addresses, phone numbers, etc.); information about a user's scheduled appointments and events; notes; and/or other types of information, examples of which are described below. In some embodiments, storage subsystem 204 can also store one or more application programs (or apps) 234 to be executed by processing subsystem 210 (e.g., video game programs, personal information management programs, media playback programs, interface programs associated with particular host devices and/or host device functionalities, etc.).

User interface 206 can include any combination of input and output devices. A user can operate input devices of user interface 206 to invoke the functionality of wearable device 200 and can view, hear, and/or otherwise experience output from wearable device 200 via output devices of user interface 206.

Examples of output devices include display 220, speakers 222, and haptic output generator 224. Display 220 can be implemented using compact display technologies, e.g., LCD (liquid crystal display), LED (light-emitting diode), OLED (organic light-emitting diode), or the like. In some embodiments, display 220 can incorporate a flexible display element or curved-glass display element, allowing wearable device 200 to conform to a desired shape. One or more speakers 222 can be provided using small-form-factor speaker technologies, including any technology capable of converting electronic signals into audible sound waves. In some embodiments, speakers 222 can be used to produce tones (e.g., beeping or ringing) and can but need not be capable of reproducing sounds such as speech or music with any particular degree of fidelity. Haptic output generator 224 can be, e.g., a device that converts electronic signals into vibrations; in some embodiments, the vibrations can be strong enough to be felt by a user wearing wearable device 200 but not so strong as to produce distinct sounds.

Examples of input devices include microphone 226, touch sensor 228, and camera 229. Microphone 226 can include any device that converts sound waves into electronic signals. In some embodiments, microphone 226 can be sufficiently sensitive to provide a representation of specific words spoken by a user; in other embodiments, microphone 226 can be usable to provide indications of general ambient sound levels without necessarily providing a high-quality electronic representation of specific sounds.

Touch sensor 228 can include, e.g., a capacitive sensor array with the ability to localize contacts to a particular point or region on the surface of the sensor and in some instances, the ability to distinguish multiple simultaneous contacts. In some embodiments, touch sensor 228 can be overlaid over display 220 to provide a touchscreen interface (e.g., touchscreen interface 105 of FIG. 1), and processing subsystem 202 can translate touch events (including taps and/or other gestures made with one or more contacts) into specific user inputs depending on what is currently displayed on display 220.

Camera 229 can include, e.g., a compact digital camera that includes an image sensor such as a CMOS sensor and optical components (e.g. lenses) arranged to focus an image onto the image sensor, along with control logic operable to use the imaging components to capture and store still and/or video images. Images can be stored, e.g., in storage subsystem 204 and/or transmitted by wearable device 200 to other devices for storage. Depending on implementation, the optical components can provide fixed focal distance or variable focal distance; in the latter case, autofocus can be provided. In some embodiments, camera 229 can be disposed along an edge of face member 104 of FIG. 1, e.g., the top edge, and oriented to allow a user to capture images of nearby objects in the environment such as a bar code or QR code. In other embodiments, camera 229 can be disposed on the front surface of face member 104, e.g., to capture images of the user. Zero, one, or more cameras can be provided, depending on implementation.

In some embodiments, user interface 206 can provide output to and/or receive input from an auxiliary device such as a headset. For example, audio jack 230 can connect via an audio cable (e.g., a standard 2.5-mm or 3.5-mm audio cable) to an auxiliary device. Audio jack 230 can include input and/or output paths. Accordingly, audio jack 230 can provide audio to the auxiliary device and/or receive audio from the auxiliary device. In some embodiments, a wireless connection interface can be used to communicate with an auxiliary device.

Processing subsystem 202 can be implemented as one or more integrated circuits, e.g., one or more single-core or multi-core microprocessors or microcontrollers, examples of which are known in the art. In operation, processing system 202 can control the operation of wearable device 200. In various embodiments, processing subsystem 202 can execute a variety of programs in response to program code and can maintain multiple concurrently executing programs or processes. At any given time, some or all of the program code to be executed can be resident in processing subsystem 202 and/or in storage media such as storage subsystem 204.

Through suitable programming, processing subsystem 202 can provide various functionality for wearable device 200. For example, in some embodiments, processing subsystem 202 can execute an operating system (OS) 232 and various applications 234 such as a phone-interface application, a text-message-interface application, a media interface application, a fitness application, and/or other applications. In some embodiments, some or all of these application programs can interact with a host device, e.g., by generating messages to be sent to the host device and/or by receiving and interpreting messages from the host device. In some embodiments, some or all of the application programs can operate locally to wearable device 200. For example, if wearable device 200 has a local media library stored in storage subsystem 204, a media interface application can provide a user interface to select and play locally stored media items. Processing subsystem 202 can also provide wrist-gesture-based control, e.g., by executing gesture processing code 236 (which can be part of OS 232 or provided separately as desired).

RF (radio frequency) interface 208 can allow wearable device 200 to communicate wirelessly with various host devices. RF interface 208 can include RF transceiver components such as an antenna and supporting circuitry to enable data communication over a wireless medium, e.g., using Wi-Fi (IEEE 802.11 family standards), Bluetooth® (a family of standards promulgated by Bluetooth SIG, Inc.), or other protocols for wireless data communication. RF interface 208 can be implemented using a combination of hardware (e.g., driver circuits, antennas, modulators/demodulators, encoders/decoders, and other analog and/or digital signal processing circuits) and software components. In some embodiments, RF interface 208 can provide near-field communication (“NFC”) capability, e.g., implementing the ISO/IEC 18092 standards or the like; NFC can support wireless data exchange between devices over a very short range (e.g., 20 centimeters or less). Multiple different wireless communication protocols and associated hardware can be incorporated into RF interface 208.

Connector interface 210 can allow wearable device 200 to communicate with various host devices via a wired communication path, e.g., using Universal Serial Bus (USB), universal asynchronous receiver/transmitter (UART), or other protocols for wired data communication. In some embodiments, connector interface 210 can provide a power port, allowing wearable device 200 to receive power, e.g., to charge an internal battery. For example, connector interface 210 can include a connector such as a mini-USB connector or a custom connector, as well as supporting circuitry. In some embodiments, the connector can be a custom connector that provides dedicated power and ground contacts, as well as digital data contacts that can be used to implement different communication technologies in parallel; for instance, two pins can be assigned as USB data pins (D+ and D−) and two other pins can be assigned as serial transmit/receive pins (e.g., implementing a UART interface). The assignment of pins to particular communication technologies can be hardwired or negotiated while the connection is being established. In some embodiments, the connector can also provide connections for audio and/or video signals, which may be transmitted to or from host device 202 in analog and/or digital formats.

In some embodiments, connector interface 210 and/or RF interface 208 can be used to support synchronization operations in which data is transferred from a host device to wearable device 200 (or vice versa). For example, as described below, a user can customize certain information for wearable device 200 (e.g., settings related to wrist-gesture control). While user interface 206 can support data-entry operations, a user may find it more convenient to define customized information on a separate device (e.g., a tablet or smartphone) that has a larger interface (e.g., including a real or virtual alphanumeric keyboard), then transfer the customized information to wearable device 200 via a synchronization operation. Synchronization operations can also be used to load and/or update other types of data in storage subsystem 204, such as media items, application programs, personal data, and/or operating system programs. Synchronization operations can be performed in response to an explicit user request and/or automatically, e.g., when wireless device 200 resumes communication with a particular host device or in response to either device receiving an update to its copy of synchronized information.

Environmental sensors 214 can include various electronic, mechanical, electromechanical, optical, or other devices that provide information related to external conditions around wearable device 200. Sensors 214 in some embodiments can provide digital signals to processing subsystem 202, e.g., on a streaming basis or in response to polling by processing subsystem 202 as desired. Any type and combination of environmental sensors can be used; shown by way of example are accelerometer 242, a magnetometer 244, a gyroscope 246, and a GPS receiver 248.

Some environmental sensors can provide information about the location and/or motion of wearable device 200. For example, accelerometer 242 can sense acceleration (relative to freefall) along one or more axes, e.g., using piezoelectric or other components in conjunction with associated electronics to produce a signal. Magnetometer 244 can sense an ambient magnetic field (e.g., Earth's magnetic field) and generate a corresponding electrical signal, which can be interpreted as a compass direction. Gyroscopic sensor 246 can sense rotational motion in one or more directions, e.g., using one or more MEMS (micro-electro-mechanical systems) gyroscopes and related control and sensing circuitry. Global Positioning System (GPS) receiver 248 can determine location based on signals received from GPS satellites.

Other sensors can also be included in addition to or instead of these examples. For example, a sound sensor can incorporate microphone 226 together with associated circuitry and/or program code to determine, e.g., a decibel level of ambient sound. Temperature sensors, proximity sensors, ambient light sensors, or the like can also be included.

Strap sensors 216 can include various electronic, mechanical, electromechanical, optical, or other devices that provide information as to whether wearable device 200 is currently being worn, as well as information about forces that may be acting on the strap due to movement of the user's wrist. Examples of strap sensors 216 are described below. In some embodiments, signals from sensors 216 can be analyzed, e.g., using gesture processing code 236, to identify wrist gestures based on the sensor signals. Such gestures can be used to control operations of wearable device 200. Examples of wrist gestures and gesture processing are described below.

Power subsystem 212 can provide power and power management capabilities for wearable device 200. For example, power subsystem 212 can include a battery 240 (e.g., a rechargeable battery) and associated circuitry to distribute power from battery 240 to other components of wearable device 200 that require electrical power. In some embodiments, power subsystem 212 can also include circuitry operable to charge battery 240, e.g., when connector interface 210 is connected to a power source. In some embodiments, power subsystem 212 can include a “wireless” charger, such as an inductive charger, to charge battery 240 without relying on connector interface 210. In some embodiments, power subsystem 212 can also include other power sources, such as a solar cell, in addition to or instead of battery 240.

In some embodiments, power subsystem 212 can control power distribution to components within wearable device 200 to manage power consumption efficiently. For example, power subsystem 212 can automatically place device 200 into a “hibernation” state when strap sensors 216 or other sensors indicate that device 200 is not being worn. The hibernation state can be designed to reduce power consumption; accordingly, user interface 206 (or components thereof), RF interface 208, connector interface 210, and/or environmental sensors 214 can be powered down (e.g., to a low-power state or turned off entirely), while strap sensors 216 are powered up (either continuously or at intervals) to detect when a user puts on wearable device 200. As another example, in some embodiments, while wearable device 200 is being worn, power subsystem 212 can turn display 220 and/or other components on or off depending on motion and/or orientation of wearable device 200 detected by environmental sensors 214. For instance, if wearable device 200 is designed to be worn on a user's wrist, power subsystem 212 can detect raising and rolling of a user's wrist, as is typically associated with looking at a wristwatch, based on information provided by accelerometer 242. In response to this detected motion, power subsystem 212 can automatically turn display 220 and/or touch sensor 228 on; similarly, power subsystem 212 can automatically turn display 220 and/or touch sensor 228 off in response to detecting that user's wrist has returned to a neutral position (e.g., hanging down).

Power subsystem 212 can also provide other power management capabilities, such as regulating power consumption of other components of wearable device 200 based on the source and amount of available power, monitoring stored power in battery 240, generating user alerts if the stored power drops below a minimum level, and so on.

In some embodiments, control functions of power subsystem 212 can be implemented using programmable or controllable circuits operating in response to control signals generated by processing subsystem 202 in response to program code executing thereon, or as a separate microprocessor or microcontroller.

It will be appreciated that wearable device 200 is illustrative and that variations and modifications are possible. For example, strap sensors 216 can be modified, and wearable device 200 can include a user-operable control (e.g., a button or switch) that the user can operate to provide input. Controls can also be provided, e.g., to turn on or off display 220, mute or unmute sounds from speakers 222, etc. Wearable device 200 can include any types and combination of sensors and in some instances can include multiple sensors of a given type.

In various embodiments, a user interface can include any combination of any or all of the components described above, as well as other components not expressly described. For example, in some embodiments, the user interface can include, e.g., just a touchscreen, or a touchscreen and a speaker, or a touchscreen and a haptic device. Where the wearable device has an RF interface, a connector interface can be omitted, and all communication between the wearable device and other devices can be conducted using wireless communication protocols. A wired power connection, e.g., for charging a battery of the wearable device, can be provided separately from any data connection.

Further, while the wearable device is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software. It is also not required that every block in FIG. 2 be implemented in a given embodiment of a wearable device.

A host device such as host device 102 of FIG. 1 can be implemented as an electronic device using blocks similar to those described above (e.g., processors, storage media, user interface devices, data communication interfaces, etc.) and/or other blocks or components. Those skilled in the art will recognize that any electronic device capable of communicating with a particular wearable device can act as a host device with respect to that wearable device.

Communication between a host device and a wireless device can be implemented according to any communication protocol (or combination of protocols) that both devices are programmed or otherwise configured to use. In some instances, standard protocols such as Bluetooth protocols can be used. In some instances, a custom message format and syntax (including, e.g., a set of rules for interpreting particular bytes or sequences of bytes in a digital data transmission) can be defined, and messages can be transmitted using standard serial protocols such as a virtual serial port defined in certain Bluetooth standards. Embodiments of the invention are not limited to particular protocols, and those skilled in the art with access to the present teachings will recognize that numerous protocols can be used.

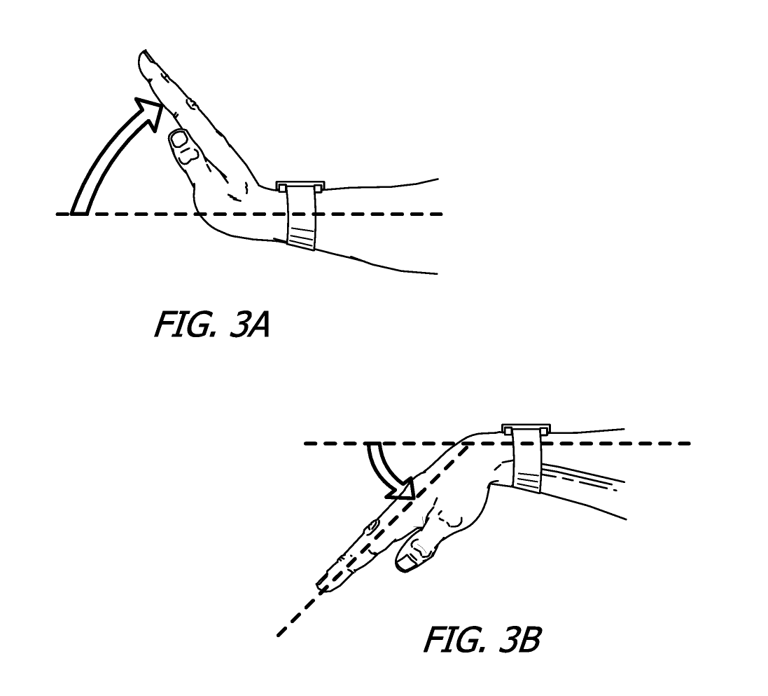

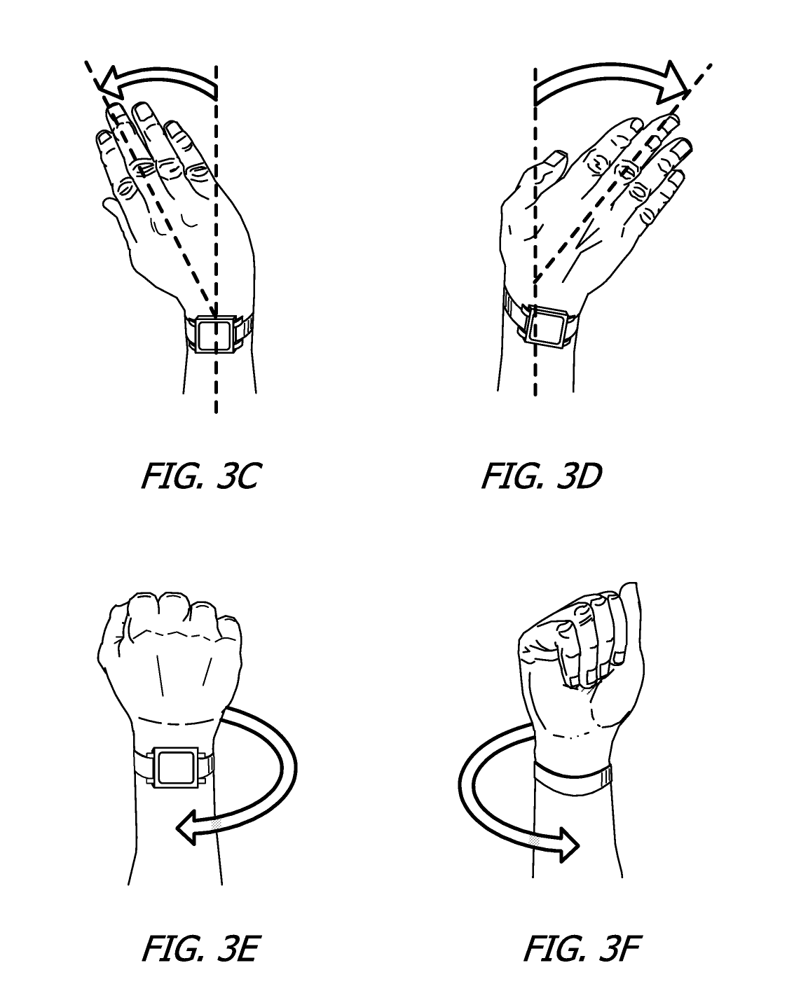

Certain embodiments of the present invention allow a user to control the wireless device and/or the host device using articulations of the wrist. As used herein, an articulation of the wrist refers generally to any movement that changes the orientation of a user's hand relative to the user's forearm away from a neutral position; a return to neutral is referred to as releasing the articulation. As shown in FIGS. 3A-3F, a wrist can articulate in a number of directions, including extension (or dorsiflexion) as shown in FIG. 3A, in which the back of the hand is rotated toward the forearm; flexion (or palmar flexion) as shown in FIG. 3B, in which the palm of the hand is rotated toward the forearm; abduction (or radial deviation) as shown in FIG. 3C, a motion in the plane of the palm of the hand that brings the thumb toward the forearm; adduction (or ulnar deviation) as shown in FIG. 3D, a motion in the plane of the palm of the hand that brings the pinky toward the forearm; pronation (or inward rotation) as shown in FIG. 3E, a motion that rotates the hand about an axis parallel to the forearm in the direction of the thumb; and supination (or outward rotation) as shown in FIG. 3F, a rotation in the opposite direction from pronation.

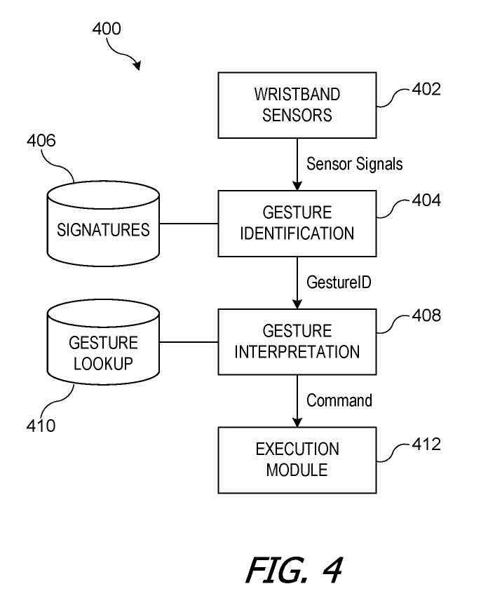

In various embodiments, some or all of these articulations can be detected and used as a user input mechanism. FIG. 4 is a simplified block diagram of a wrist-gesture processing system 400 that can be included in a wearable device (e.g., wearable device 100 of FIG. 1 or wearable device 200 of FIG. 2) according to an embodiment of the present invention. System 400 can include one or more wristband (or strap) sensors 402, a gesture identification module 404 that accesses a gesture library 406, a gesture interpretation module 408 that accesses a gesture lookup data store 410, and an execution module 412. Modules 404, 408, and 412 can be implemented as software, e.g., as part of gesture processing code 236 of wearable device 200.

Wristband sensors 402 can include sensors that detect forces applied to the wristband or portions thereof. Any type or combination of sensors can be used. For instance, sensors 402 can include displacement sensors that detect movement of one portion of the wristband relative to another or relative to the face portion, indicative of an applied force; deformation sensors that detect stretching or contracting of the wristband indicative of an applied force; and/or pressure sensors that detect changes in pressure (force per unit area) applied to specific regions of an inside surface of the wristband. Specific examples of sensors are described below. Sensors 402 can produce sensor signals that can be analyzed, e.g., using fixed-function or programmable logic circuits. In some embodiments, sensor signals are generated in analog form and converted to digital data prior to analysis.

Gesture identification module 404 can receive the sensor data (e.g., in digital form). Gesture identification module 404 can access a data store 406 of “signatures” associated with specific wrist gestures. As used herein, a wrist gesture (also referred to simply as a gesture) refers to a specific wrist articulation or sequence of wrist articulations that a user can execute, such as extend-and-release, extend-and-hold, double-extend (extend-release-extend-release), flex-and-release, flex-and-hold, double-flex (flex-release-flex-release), and so on. The signature for a gesture can include a sequence of sensor data values for one or more sensors that is expected to occur when a user executes the corresponding gesture. In some embodiments, signatures for various wrist gestures can be generated by operating gesture identification module 404 in a training mode, in which the user executes specific wrist gestures in response to prompts and sensor data is collected while the user executes the gesture. The user can be prompted to execute a particular gesture multiple times during training, and statistical analysis of the sensor data from different instances of execution can be used to further define a signature for a gesture. In other embodiments, signatures can be generated prior to distributing the device to an end user, e.g., based on analysis of sensor response to gestures performed by a number of different test users. In still other embodiments, a combination of user-specific training and pre-distribution analysis can be used to define signatures for various gestures.

During normal operation (when not in training mode), gesture identification module 404 can compare received sensor data to the signatures in signature data store 406 and identify a gesture based on the best match between the received sensor signals and one of the signatures in data store 406. Various analysis techniques can be used to perform the comparison. For example, gesture identification module 404 can compute a correlation metric indicating a degree of correlation between the received sensor data and various signatures and identify the gesture based on the signature that has the strongest correlation with the received data.

The output from gesture identification module 404 can be a GestureID code indicating the gesture that best matched the sensor signal. In some embodiments, gesture identification module 404 can produce a null result (no gesture matched), e.g., if the correlation metric for every signature is below a minimum threshold. Requiring a minimum threshold to detect a gesture can help avoid interpreting other user motions as gesture inputs. In some embodiments, gesture identification module 404 can produce an ambiguous result (multiple gestures matched), e.g., if the highest correlation metric and second highest correlation metric are within a tolerance limit of each other; in this case, multiple GestureIDs can be output, and the intended gesture can be disambiguated at a later stage.

Gesture interpretation module 408 can receive the GestureID from gesture identification module 404 and map the gesture to an action or command. As used herein, an “action” refers generally to a function that is to be invoked, and a “command” refers to generally a control signal that can be provided to an appropriate component of the wearable device (represented in FIG. 4 as execution module 412) to invoke the function. In some embodiments, any function that the wearable device is capable of executing can be mapped to a gesture. For example, gesture lookup data store 410 can include a lookup table that maps a GestureID to a command. A gesture can be mapped to an action that in turn maps to a command or directly to a command as desired.

In some instances, the mapping can be context-sensitive, i.e., dependent upon the current state of the wearable device. For instance, lookup data store 410 can include multiple lookup tables, each associated with a different context such as “home state,” “media player,” “phone interface,” etc. A particular GestureID, such as an ID associated with an extend-and-release gesture, can map to different functions in different contexts. Specific examples of gesture mappings to device functions (or actions) are described below.

Where the gesture identification is ambiguous, gesture interpretation module 406 can attempt to resolve the ambiguity. For instance, if two or more GestureIDs are received from gesture identification module 404, gesture interpretation module 406 can determine whether only one of the GestureIDs corresponds to a gesture that is defined within the current context or device state. If so, gesture interpretation module 406 can select the defined gesture. If multiple gestures matching the received GestureIDs are defined in the current context, gesture interpretation module 406 can ignore the input or select among the received GestureIDs.

Execution module 412 can include any component of the wearable device that can perform a function in response to a command. In various embodiments, execution module 412 can include aspects of operating system 232 and/or apps 234 of FIG. 2.

Examples of sensors that can be used to detect wrist articulations will now be described.

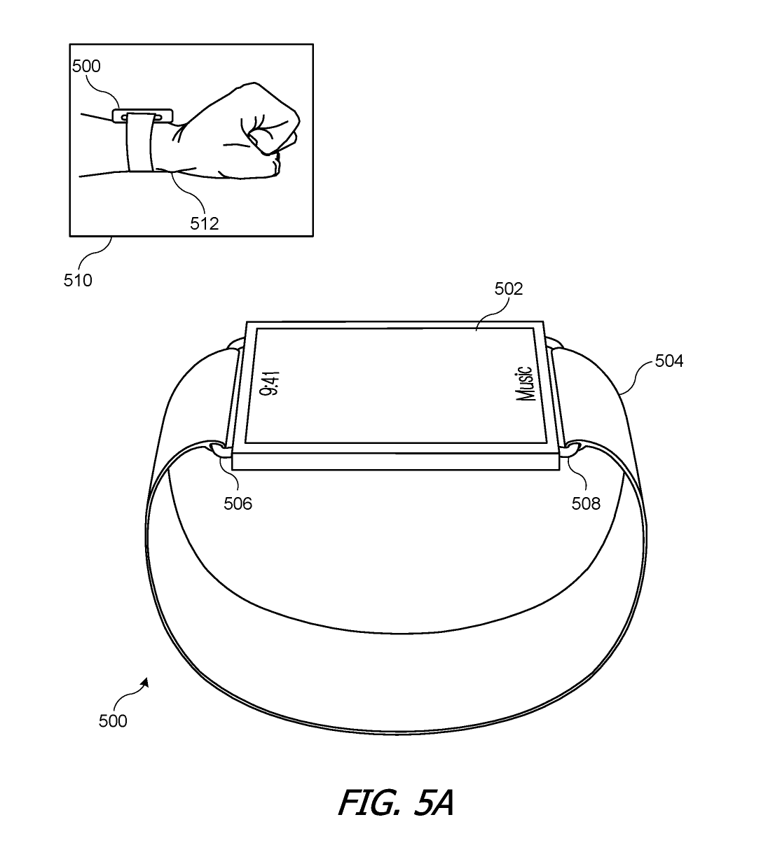

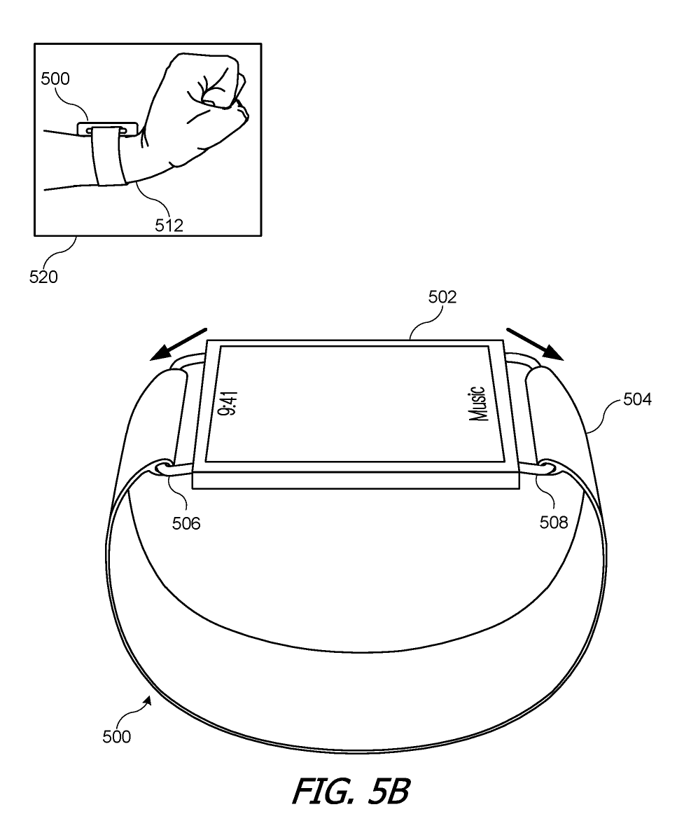

FIGS. 5A and 5B illustrate one technique for detecting wrist extension (or dorsiflexion) using sensors according to an embodiment of the present invention. FIG. 5A shows a wrist device 500 having a face member 502 and a strap 504. Strap 504 is connected to face member 502 using expandable strap holders 506, 508 disposed along top and bottom sides of face member 502. Inset 510 shows a user wearing device 500 with wrist 512 in a neutral position. As shown in FIG. 5B, when the user's wrist extends (inset 520), expandable strap holders 506, 508 expand. This expansion can occur, e.g., as a result of the user's wrist changing shape during extension and/or as a result of the back of the user's hand or wrist pressing against face member 502. Sensors disposed adjacent to or within expandable strap holders 506, 508 can detect the expansion and generate a signal indicative of flexion.

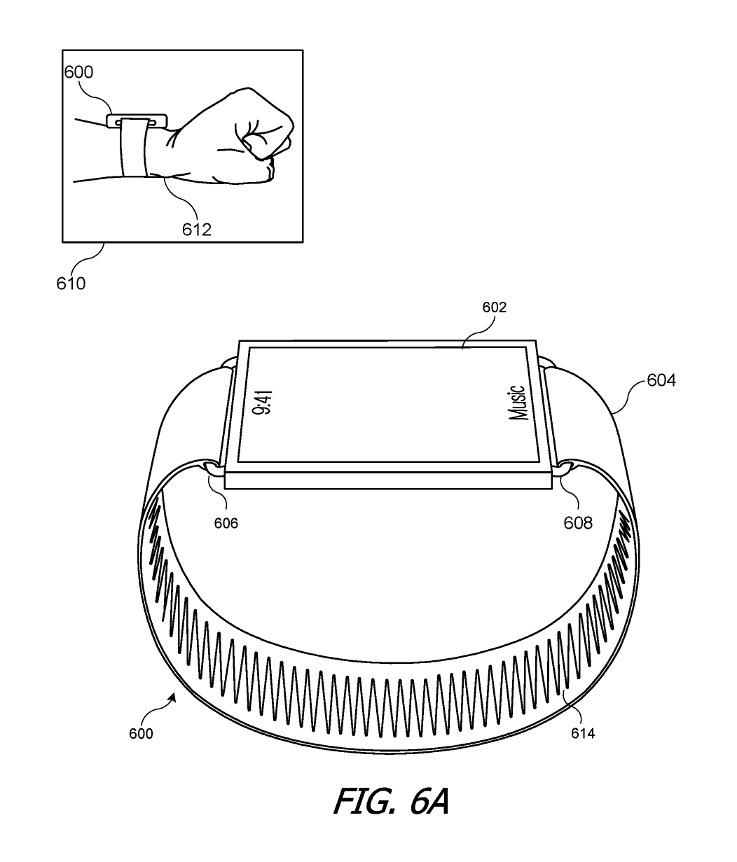

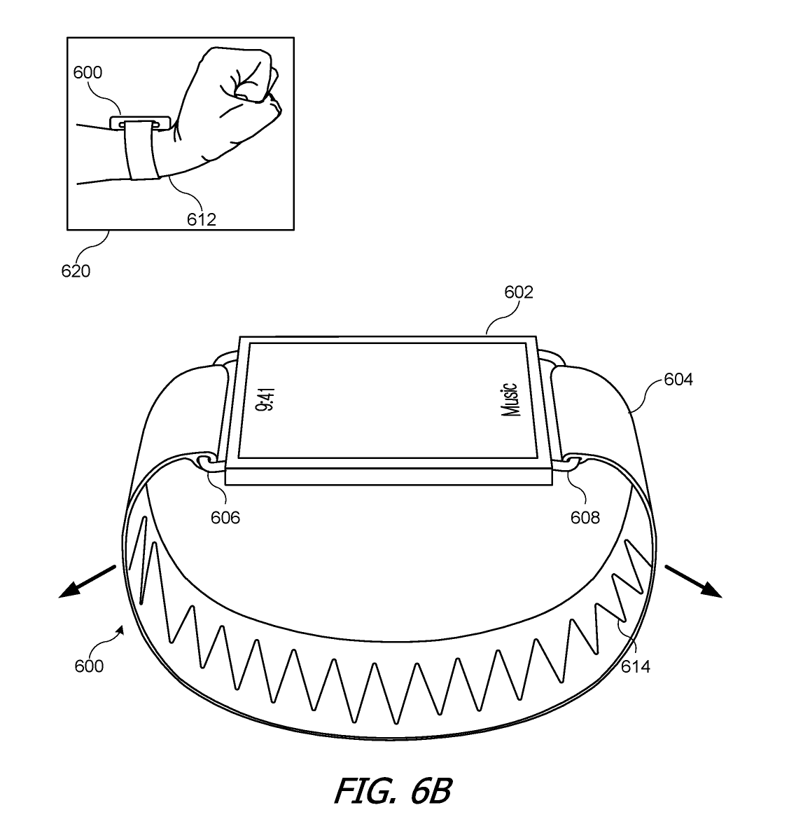

FIGS. 6A and 6B illustrate another technique for detecting wrist extension (or dorsiflexion) using sensors according to an embodiment of the present invention. FIG. 6A shows a wrist device 600 having a face member 602 and an elastic strap 604 secured to face member 602 using fixed strap holders 606, 608 disposed along top and bottom sides of face member 602. Inset 610 shows a user wearing wrist device 600 with wrist 612 in a neutral position. As shown in FIG. 6B, when the user's wrist extends (inset 620), elastic strap 604 expands. (For purposes of illustrating the expansion, elastic strap 604 is shown with a zigzag pattern 614). Expansion of elastic strap 604 can be detected, e.g., using a strain gauge wire or the like that is at least partially embedded in the elastic material of strap 604 and that provides increased electrical resistance when stretched. In some embodiments, only a portion of strap 604 is elastic, and expansion of the elastic portion can be detected.

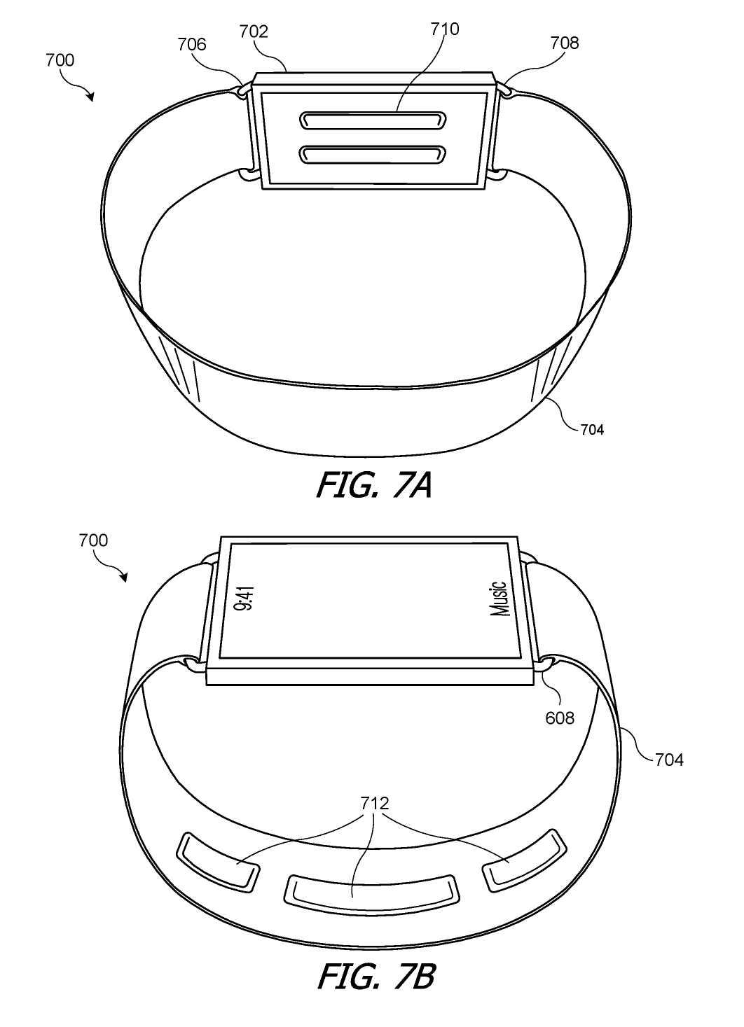

FIGS. 7A and 7B illustrate a technique for detecting wrist articulations using pressure sensors according to an embodiment of the present invention. FIG. 7A shows a wrist device 700 having a face member 702 and a strap 704 secured to face member 702 using fixed strap holders 706, 708 disposed along top and bottom surfaces of face member 702. One or more pressure sensors 710 can be disposed on the inward-facing surface of face member 702 such that sensors 710 can be in contact with the user's wrist when device 700 is worn. As shown in FIG. 7B, wrist device 700 can also have one or more pressure sensors 712 disposed on an interior side of strap 704 such that at least some of sensors 712 are in contact with the user's wrist when device 700 is worn. A wrist articulation can change the distribution of pressure on sensors 710, 712. For example, palmar flexion can increase the pressure at one or more of sensors 710 while decreasing pressure at one or more of sensors 712; dorsiflexion (extension) can have the opposite effect. Abduction, adduction, pronation, and supination can also be distinguished based on patterns of pressure changes on suitably disposed pressure sensors. In some embodiments, proximity sensors can be used in addition to or instead of pressure sensors. For suitable strap materials, localized expansion or strain sensors or the like can also be used.

It will be appreciated that the sensor examples described herein are illustrative and that variations and modifications are possible. In various embodiments, sensors can detect deformation or movement of a wrist strap or face member (or a localized portion thereof), stress or strain on the wrist strap or face member (or a localized portion thereof), pressure on the wrist strap or a portion of the wrist strap or face member, or any other force acting on the wrist strap or a portion of the wrist strap or the face member, as well as proximity of a user's skin (or possibly other surfaces) to the sensor. While the detected forces, deformations, stresses and strains, pressures, etc., to which the sensors respond can be the result of a wrist articulation, this is not necessarily the case in every instance where a change is detected. Other causes can create a sensor response, and these other causes might not always be distinguishable from wrist articulations. In some embodiments, multiple sensors and sensor types can be deployed in a single wrist-worn device, and correlations among signals and/or data received from different sensors can be used to distinguish wrist articulations from other causes.

Any combination of the above and/or other sensors within a wristband and/or a wrist-worn device can be used to detect a wrist articulation and/or to facilitate distinguishing among different types of wrist articulation.

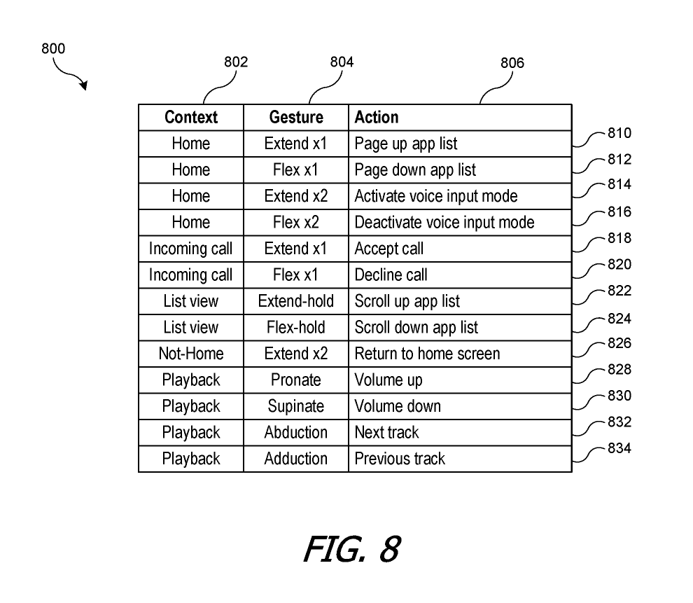

As described above, sensor data can be analyzed to detect wrist gestures, which in turn can be mapped to actions to be taken by the wearable device and/or to specific command signals that induce the actions. FIG. 8 shows a table 800 defining a portion of a wrist-gesture library for a wearable device (e.g., wearable device 100 of FIG. 1) according to an embodiment of the present invention. In this example, a wrist gesture (column 804) is interpreted based on the current operating context of a wearable device (column 802) to determine a corresponding action (column 806). A further mapping of actions to commands and/or control signals that initiate the action is not shown; those skilled in the art will recognize that particular commands or control signals depend on the particular implementation of the wearable device.

In this example, it is assumed that wearable device 100 has a “home” state in which it presents a home screen that can include a menu of applications (or apps) that the user can launch to execute functions. Any number and combination of apps can be supported, including music playback apps, communications apps (telephony, text messaging, etc.), voice recording apps, information presentation apps (stocks, news headlines, etc.), fitness apps (logging and/or reviewing workout or other activity data, etc.), and so on. The user can use wrist flexion to page up and down the menu of apps, which can be presented, e.g., as a list or array of icons that represent the apps. In this example, a single extension-release gesture (line 810) pages down the list or array, and a single flexion-release gesture (line 182) scrolls up the list or array.

In this example, it is also assumed that the wearable device supports a voice-input mode, where the user can invoke functions or make requests by speaking; a voice interpreter (which can be in the wearable device or in another device with which the wearable device communicates) processes detected speech sounds to determine what request is being made, enabling the device to act on the request. In the home state in this example, a double-extension gesture (extending and releasing twice in quick succession (line 814)) can activate the voice-input mode, e.g., turning on a microphone and the voice interpreter; a double-flexion (flexing and releasing twice in quick succession (line 816)) can deactivate the voice-input mode.

If the wearable device is capable of receiving phone calls (or is paired with another device, such as a mobile phone, that is capable of receiving phone calls), the wearable device can enter an “incoming call” context when a call is received. In this context, the interpretation of certain wrist gestures can change. For example, as shown in table 800, in the incoming-call context, a single extension (line 818) can be used to accept (e.g., answer) an incoming call while a single flexion (line 820) can be used to decline the call (e.g., diverting the call to voice mail).

As another example, a user may launch an app that can provide a list view, such as a list of the user's contacts or a list of media assets available to be played. While viewing such a list, the user can scroll the list using wrist gestures. For example, a flex-and-hold gesture (line 822) can initiate scrolling down, and the scrolling can continue until the user releases the flexion (returning the wrist to a neutral position) or the end of the list is reached. Similarly, an extend-and-hold gesture (line 824) can initiate scrolling up, and the scrolling can continue until the user releases the extension or the beginning of the list is reached.

As another example, a wrist gesture, such as double-extension (line 826), can be defined to provide a quick return to the home screen at any time the device is displaying something else. Thus, for example, the user can double-extend to return to the home screen, then double-extend again to activate voice input.

Wrist articulations other than flexion and extension can be used to define gestures. For example, during media playback, wrist rotations (pronation and supination) can be used for volume control (lines 828, 830); wrist deviations (abduction and adduction) can be used to advance to the next track or return to a previous track (lines 832, 834).

It will be appreciated that table 800 is illustrative and that variations and modifications are possible. Any number and combination of wrist gestures can be defined, and the contexts in which gestures are defined can also be varied. In some embodiments, the user may be able to customize a gesture library, e.g., using a settings menu or the like; a settings menu interface can be provided on the wearable device or another device that is capable of communicating the user's preferences to the wearable device. In some embodiments, third-party developers of apps may be able to define the interpretation of various wrist gestures within the context of their apps.

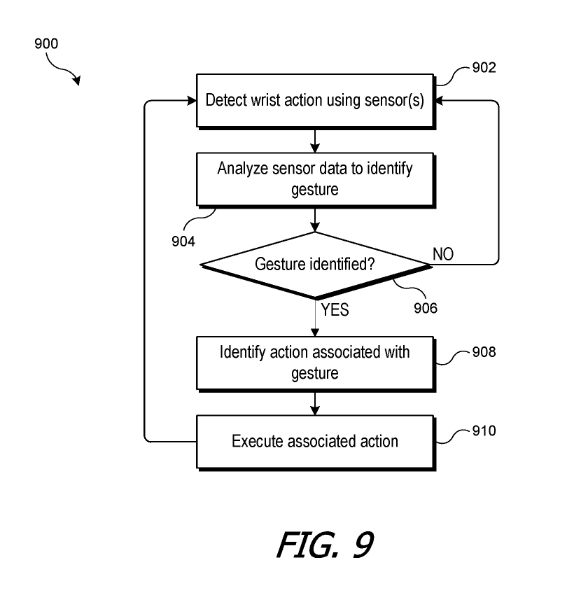

FIG. 9 is a flow diagram of a process 900 for controlling a wrist-worn device using wrist gestures according to an embodiment of the present invention. Process 900 can be implemented, e.g., using wrist-gesture processing system 400 of FIG. 4 or other components of a wrist-worn device.

At block 902, wrist action can be detected using sensors such as wristband sensors 402 of FIG. 4. These sensors can include any or all of the sensors described above with reference to FIGS. 5A-5B, 6A-6B, and/or 7A-7B, and/or other sensors. At block 904, the sensor data can be analyzed to identify gestures, e.g., using gesture identification module 404 described above. At block 906, if no gesture is identified, process 900 can return to block 902 to await further sensor input.

In some embodiments, process 900 can sample sensor data readings over a period of time, and the analysis at block 904 can be performed on a rolling window of the most recent sensor data samples. The duration of the window can be chosen to be large enough that a user would likely execute an intended wrist gesture within the corresponding time interval (e.g., half a second, one second, two seconds, depending on what gestures are defined). Process 900 can be repeated at intervals much shorter than the duration of the window (e.g., hundreds of times per second), so that a user can initiate a gesture at any time.

If, at block 906, a gesture is identified, then at block 908, process 900 can identify an action associated with the gesture, e.g., using gesture interpretation module 408 described above. Action identification can include using a lookup table as described above, and in some embodiments, the identification can be dependent on the current context (e.g., operating state) of the wearable device. At block 910, the action can be executed. For example, as described above, gesture interpretation module 408 can send an appropriate command (or multiple commands) to execution module 412, which can perform the action in response to the command. Thereafter, process 900 can continue to detect wrist action and interpret the action as gestures.

It will be appreciated that process 900 is illustrative and that variations and modifications are possible. Steps described as sequential may be executed in parallel, order of steps may be varied, and steps may be modified, combined, added or omitted. For instance, identifying a gesture and the associated action can be consolidated into a single operation. Various algorithms can be used to identify a gesture based on sensor data, depending in part on the set of sensors available and the set of gestures to be distinguished.

In some embodiments, additional analysis can be performed to reduce “noise,” or false detection of gestures due to incidental movement of the user's hand. For example, if the wrist-worn device includes an accelerometer, data from the accelerometer can be used to determine if the user's arm is in motion, e.g., as in walking, swimming, swinging a golf club, gesticulating while speaking, or other activity. Where such user activity is detected, recognition of wrist gestures can be suppressed entirely, or more stringent criteria for gesture identification can be applied to reduce the likelihood of inadvertently executing an undesired action. Similarly, if the wrist-worn device has sensors capable of detecting whether the user is looking at the device's display (e.g., a front-facing camera on face portion 104 combined with image analysis software to detect a face and/or eyes), gesture identification criteria can be modified based on whether the user is or is not looking at the display. For instance, it might be assumed that the user is less likely to intend a motion as a gesture to interact with the device if the user is not actually looking at the display, and recognition of wrist gestures can be suppressed entirely or more stringent criteria applied when the user is believed to be not looking at the display.

Process 900 can execute continuously while device 100 is being worn. In some embodiments, process 900 can be disabled if device 100 enters a state in which wrist gestures are not expected to occur. For example, in some embodiments, device 100 can determine whether it is currently being worn, and process 900 can be disabled if device 100 determines that it is not being worn. Similarly, as noted above, if device 100 can determine that the user is engaged in a physical activity that involves arm motion or is not looking at the display, then process 900 can be disabled (or can continue to execute with more stringent criteria for gesture identification).

As noted above, in some embodiments, the user can customize the device's behavior. For instance, the user can choose whether to enable or disable wrist-gesture recognition globally, and/or to assign interpretations to particular wrist gestures.

While the invention has been described with respect to specific embodiments, one skilled in the art will recognize that numerous modifications are possible. For example, while the description makes references to specific wrist articulations such as extension and flexion, other wrist motions can also be sensed using suitable sensors in a wrist strap, interpreted as gestures, and used to invoke device functions, including radial deviation, ulnar deviation, pronation, and/or supination. Any device function or combination of functions can be invoked using wrist gestures, provided that the wearable device is capable of distinguishing the different gestures, and the mapping of particular gestures to particular functions can be varied.

Further, while certain embodiments described above are capable of recognizing and distinguishing among multiple wrist gestures and invoking different functions in response to different gestures, other embodiments can operate with just a single recognized wrist gesture. For instance, an extend-and-release gesture can be defined, and gesture identification can be performed by determining from sensor data whether that gesture was made. The single recognized wrist gesture can be mapped globally to a particular function (e.g., returning to a home screen), or the mapping can be context dependent (e.g., toggle play/pause if the wrist-worn device is currently executing a media playback app, answer an incoming call if the wrist-worn device is currently displaying an incoming call alert, etc.). In some embodiments, a wrist gesture can be used to wake the device from a sleep state (e.g., any reduced-power state); waking the device can include functions such as turning on a display and/or a user input component such as a touch sensor or microphone.

Embodiments described above rely on sensor data from the wrist-worn device, in particular, data from sensors embedded in the wristband and/or the face member of the device. Relying on sensors within the wrist-worn device can reduce encumbrances on the user while allowing gesture-based control. For instance, a user can execute a wrist gesture without needing to free up a hand to touch a control, which can be convenient, e.g., if the user is carrying something, driving, or doing some other task that occupies one or both hands. Further, the user need not wear cumbersome gloves or remain in the field of view of an external sensor as is required by other motion-based control systems; thus, the user is free to move about and engage in normal activity.

In some instances, data from other sensors or devices can also be used in combination with the embedded sensors. For example, if the wrist-worn device is paired with another mobile device (e.g., as shown in FIG. 1), data from the other mobile device (e.g., accelerometer data, GPS data) may provide further indications as to what the user is doing and whether it is likely or unlikely that the user would be making wrist gestures intended to operate the wrist-worn device.

In some embodiments, other input modalities can be combined with wrist-gesture input. For example, as described above, a wrist gesture can be used to activate a voice input mode, allowing the user to speak instructions to the device after executing the appropriate wrist gesture. Wrist gestures can also be used in combination with touchscreens, touchpads, buttons, and other types of input controls. For instance, wrist gestures can be used to enable or disable a touchscreen, or a control operable from a touchscreen can be used to enable or temporarily disable wrist-gesture recognition.

In instances where the wrist-worn device is paired with another device (e.g., as shown in FIG. 1), wrist gestures detected by the wrist-worn device can be used to control functions of the other paired device. For example, as described above, a wrist gesture can indicate that an incoming call should be answered. In some embodiments, the call is actually received by the other paired device (e.g., a mobile phone), and the wrist-worn device can communicate an instruction to the other device to answer the call in response to a detected wrist gesture.

The foregoing description may make reference to specific examples of a wearable device (e.g., a wrist-worn device) and/or a host device (e.g., a mobile phone or smart phone). It is to be understood that these examples are illustrative and not limiting; other devices can be substituted and can implement similar functional blocks and/or algorithms to perform operations described herein and/or other operations.

Embodiments of the present invention, e.g., in methods, apparatus, computer-readable media and the like, can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

1. A method of operating a wrist-worn device, the method comprising:
detecting, using a sensor on the wrist-worn device, a force acting on a band element of the wrist-worn device, the force indicative of a wrist articulation;
determining, using data from an accelerometer in the wrist-worn device, whether the user's arm is in motion;
interpreting, by a processing subsystem of the wrist-worn device, the detected force as corresponding to a wrist gesture, wherein the interpretation is based in part on the detected force and in part on whether the user's arm is in motion; and
invoking a function of the wrist-worn device based on the wrist gesture.

2. The method of claim 1 wherein the wrist gesture includes a dorsiflexion of the wrist.

3. The method of claim 1 wherein the wrist gesture includes a palmar flexion of the wrist.

4. The method of claim 1 wherein invoking the function includes activating a voice input mode of the wrist-worn device.

5. The method of claim 1 wherein invoking the function includes scrolling a list of items displayed on a display of the wrist-worn device.

6. The method of claim 1 wherein invoking the function includes waking the wrist-worn device from a sleep state.

7. The method of claim 1 wherein invoking the function includes returning the wrist-worn device to a home state.

8. (canceled)

9. The method of claim 1 wherein interpreting the detected force as corresponding to a wrist gesture includes:
matching the detected pattern to one of a plurality of wrist gestures defined in a gesture library,
wherein the plurality of wrist gestures includes a single extend-and-release gesture and a double extend-and-release gesture.

10. The method of claim 8 claim 1 wherein interpreting the detected force as corresponding to a wrist gesture includes:
matching the detected pattern to one of a plurality of wrist gestures defined in a gesture library,
wherein the plurality of wrist gestures includes an extend-and-release gesture and an extend-and-hold gesture.

11. The method of claim 1 wherein interpreting the detected force as corresponding to a wrist gesture includes comparing the detected pattern to each of a plurality of signature patterns defined in a gesture library, wherein different ones of the signature patterns correspond to different ones of the wrist gestures.

12-16. (canceled)

17. A wrist-worn device comprising:
a face member;
a wristband connected to the face member;
an accelerometer configured to detect motion of a user's arm;
a plurality of sensors disposed in one or both of the wristband and the face member, the plurality of sensors configured to generate signals in response to a wrist articulation; and
a processing subsystem coupled to the plurality of sensors and the accelerometer and configured to:
analyze the signals generated by the plurality of sensors to identify a wrist gesture, wherein the identification is based at least in part on whether the user's arm is in motion;
identify an action associated with the identified wrist gesture; and
execute the identified action.

18. The wrist-worn device of claim 17 wherein the plurality of sensors includes at least one pressure sensor disposed on a back surface of the face member.

19. The wrist-worn device of claim 17 wherein the plurality of sensors includes at least one pressure sensor disposed on an inner surface of the wristband.

20. The wrist-worn device of claim 17 wherein at least a portion of the wristband is made of an elastic material and the plurality of sensors includes at least one strain sensor disposed at least partially in the elastic material.

21. The wrist-worn device of claim 17 further comprising an expandable strap holder connected to a first end surface of the face member and to the wristband and wherein the plurality of sensors includes a sensor configured to detect expansion of the expandable strap holder.

22. The wrist-worn device of claim 17 wherein the processing subsystem is further configured such that analyzing the signals includes matching the signals to a signature of one of a plurality of wrist gestures in a gesture library.

23. The wrist-worn device of claim 22 wherein the plurality of wrist gestures in the gesture library include one or more of a dorsiflexion gesture, a palmar flexion gesture, an abduction gesture, an adduction gesture, a pronation gesture, or a supination gesture.

24. The method of claim 1 wherein in response to determining that the user's arm is in motion, the detected force is interpreted as not corresponding to any wrist gesture.

25. The method of claim 1 wherein a set of criteria for interpreting the detected force as corresponding to a wrist gesture depends on whether the user's arm is in motion.

26. The method of claim 1 further comprising:
determining whether the user is looking at a display of the wrist-worn device,
wherein a set of criteria for interpreting the detected force as corresponding to a wrist gesture depends on whether the user is looking at the display.
